(19) United States
(12) Patent Application Publication
(10) Pub. No.: US 2007/0093194 A1
(43) Pub. Date: Apr. 26, 2007

(54) Air flow control system and method for vehicle ventilation

(75) Inventors: Iuliu V. Dinescu, Aurora (CA); Thomas Woegerer, Palgrave (CA)

Correspondence Address: LANG MICHENER, BCE PLACE, P.O. BOX 747, SUITE 2500, 181 BAY STREET, TORONTO, ON, M5J 2T7, CA

(73) Assignee: Progressive Moulded Products Limited

(21) Appl. No.: 11/364,225

(22) Filed: Mar. 1, 2006

(30) Foreign Application Priority Data
Oct. 24, 2005 (CA) 2,534,191

(51) Int. Cl. B60S 1/54

(52) U.S. Cl. 454/121

(57) ABSTRACT

An air flow control system and method for vehicle ventilation operates such that the operating speed of the blower providing ventilation air is changed to substantially maintain a selected air flow rate despite changes to the state of one or more passenger-operable vents. In a first embodiment, a pressure sensor in the air flow plenum provides a signal to a speed controller which alters the operating speed of the blower in view of the measured backpressure in the plenum.

### FIELD OF THE INVENTION

The present invention relates to a vehicle ventilation system. More specifically, the present invention relates to a system and method for controlling the air flow supplied from a vehicle ventilation system.

### BACKGROUND OF THE INVENTION

Ventilation systems, including air recirculation, air conditioning and heating have become increasingly sophisticated. Such systems now commonly include thermocouples to measure passenger compartment temperatures, UV sensors to estimate Sun Load (the heat produced within the passenger compartment due to sunlight entering through the windows of the vehicle) and a microprocessor control system. The driver can input into the control system a desired temperature for the passenger compartment and the control system will activate the heater or air conditioner, as appropriate, and run a variable speed circulating fan at an appropriate speed.

However, despite the sophistication of such systems, they still suffer from some disadvantages. In particular, such systems typically include several passenger-operable vents from which the ventilation air is introduced into the vehicle. Typically, these passenger-operable vents are located in the dashboard, center console and/or seat backs and can be aimed in various directions in the passenger compartment to direct their output as desired by the passengers. Further, these passenger-operable vents can be opened or closed, or placed in intermediate, partially opened, positions by the passengers.

Present vehicle ventilation systems do not consider the state of these passenger-operable vents when setting the speed of the circulating fan. If, for example, several of the passenger-operable vents have been closed, then a circulating fan speed which would otherwise result in a comfortable air flow when all of the vents are open can, in many circumstances, result one or more passengers being uncomfortable when one or more of the passenger-operable vents are closed, or partially opened, as the air flow which would have exited the closed vents exits the opened vents with a correspondingly higher flow rate.

Further, when one or more passenger-operable vents are closed, or partially open, there is an operating speed of the variable speed fan beyond which no additional air flow is created and the only net effect obtained in such a circumstance is to waste energy operating the fan at such speeds.

### SUMMARY OF THE INVENTION

It is an object of the present invention to provide a novel air flow control system and method for vehicle ventilation which obviates or mitigates at least one disadvantage of the prior art.

According to a first aspect of the present invention, there is provided an air flow control system and method for vehicle ventilation comprises: a ventilation air plenum; at least two passenger-operable vents to provide ventilation air from the plenum to the interior of the vehicle, the vents being passenger-operable to move between closed, partially opened and opened states; a variable speed air flow blower to provide ventilation air to the plenum; a control unit operable to select a desired ventilation air flow rate; at least one sensor operable to output a signal representing air flow through the passenger-operable vents in the open state; and a speed controller responsive to the control unit and the signal from the at least one pressure sensor to alter the operating speed of the blower to substantially maintain the desired air flow rate from each passenger-operable vent which is in the open state despite changes in the state of another passenger-operable vent.

Preferably, the at least one sensor is a pressure sensor operable to indicate the pressure in the plenum. Also preferably, the blower obtains the ventilation air from a heat exchanger which is a heater and air conditioning unit.

The present invention provides an air flow control system and method for vehicle ventilation. The system and method operates such that the operating speed of the blower providing ventilation air is changed to substantially maintain a selected air flow rate despite changes to the state of one or more passenger-operable vents. In a first embodiment, a pressure sensor in the air flow plenum provides a signal to a speed controller which alters the operating speed of the blower in view of the measured backpressure in the plenum.

### BRIEF DESCRIPTION OF THE DRAWINGS

Preferred embodiments of the present invention will now be described, by way of example only, with reference to the attached Figures, wherein:

FIG. 1 shows a schematic representation of a prior art vehicle ventilation system;

FIG. 2 shows a schematic representation of a vehicle ventilation system in accordance with the present invention;

### DETAILED DESCRIPTION OF THE INVENTION

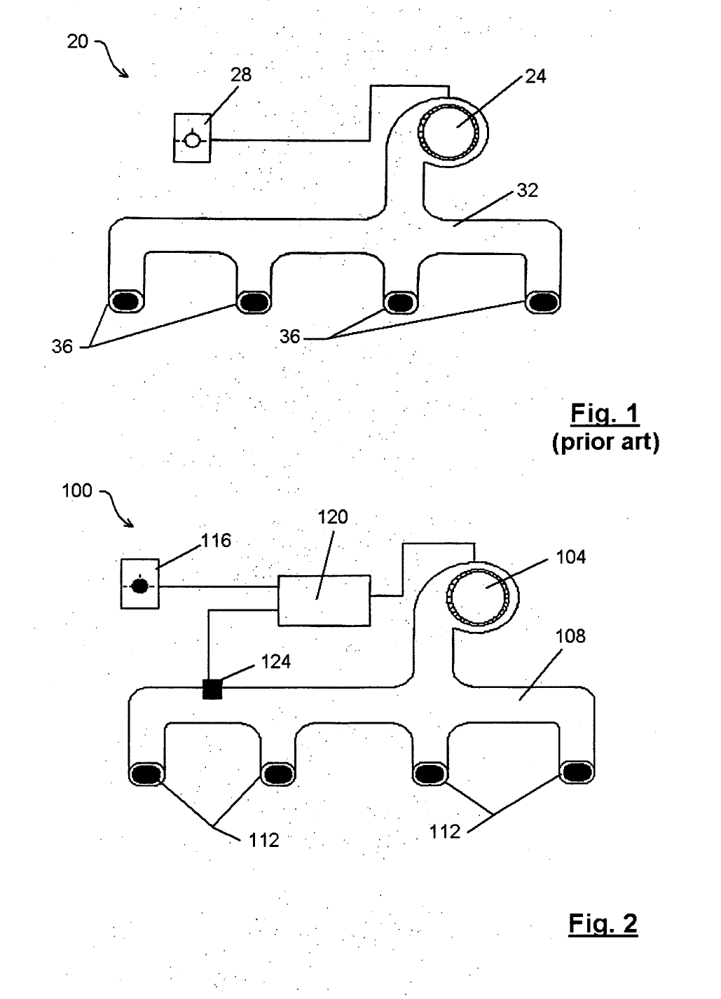

Before discussing the present invention, a prior at vehicle ventilation system will first be described for clarity. Prior art ventilation system 20, shown in FIG. 1, includes a variable speed blower 24 whose speed is controlled by a control unit 28, which can be a control provided directly to the occupants of the vehicle or which can be part of a thermostatic control system, etc.

Blower 24 draws air from a heat exchanger (not shown), which can be a heater or air conditioner, and provides it under pressure to a distribution plenum 32 to which a variety of ventilation outlets 36 are connected. The particular pressure with which the air is supplied to plenum 32 by blower 24 depends upon the operating speed set by control unit 28. If one or more of vents 36 are passenger-operable vents, then opening and/or closing of such passenger operable vents will alter the speed, and volume, of the air at which exits vents 36. For example, if blower 24 is operating at a given speed providing an air flow to the passenger compartment which is comfortable to the passengers with all of vents 36 open and then a passenger closes one vent 36, the speed, volume and force with which air from blower 24 exits the remaining vents 36 will increase. Such an increase can result in one or more air flows from open vents 36 being uncomfortable to the passengers.

Conversely, if control unit 28 has set the operating speed of blower 24 to provide a comfortable air flow to the passengers when two of vents. 36 have been closed and, subsequently, a passenger has opened either or both of the closed vents, the resulting air flow through all of the open vents 36 may be too low for passenger comfort.

FIG. 2 shows a first embodiment of a vehicle ventilation system 100 in accordance with the present invention. System 100 comprises a variable speed blower 104 which draws air from a heat exchanger (not shown), which can be a heater or air conditioner, and provides it under pressure to a distribution plenum 108 to which a variety of ventilation outlets 112 are connected.

System 100 further comprises a control unit 116 which can be a control provided directly to the occupants of the vehicle or which can be part of a thermostatic control system, etc. Control unit 116 provides an appropriate signal to a speed controller 120 which also receives an output signal from a pressure sensor 124 in plenum 108. Pressure sensor 124 provides an output signal which indicates the pressure (relative to ambient pressure) of the air flow in plenum 108. Speed controller 120 is responsive to both inputs to it such that, once a desired operating condition has been established by the occupants of the vehicle with control unit 116, speed controller 120 will alter the operating speed of blower 104 in response to pressure changes in plenum 108, as indicated by corresponding changes in the output of pressure sensor 124.

For example, if two passenger-operable vents 112 are closed and the occupants of the vehicle have set control unit 116 to provide a comfortable flow rate from the remaining vents 112, any drop in the air pressure in plenum 108, which can result from a vehicle occupant opening one or both of the closed passenger-operable vents, will result in speed control unit 120 increasing the operating speed of blower 104 to attempt to raise the pressure in plenum 108 back to its previous level. By attempting to maintain the pressure in plenum 108 at a substantially constant level, changes in the volume and/or force with which ventilation air exits a vent 112 due to the opening or closing of other vents 112 are mitigated.

In circumstances wherein a change in the setting of control 116 that requires an increase in the operating speed of blower 104, but where such a speed increase cannot result in a further increase in the pressure in plenum 108, speed control 120 operates to limit the speed of blower 104 to the maximum useful speed of blower 104, thus saving energy and reducing operating noise of ventilation system 104.

As will be apparent to those of skill in the art, speed controller 120 can be constructed in a variety of manners, including a microprocessor-based controller algorithmically setting the speed of blower 104, or a microprocessor-based controller using a lookup table of appropriate pressures and speeds for the particular vehicle in which system 100 is installed or an analog or suitable mechanical control system as will be apparent to those of skill in the art.

The construction of passenger operable vents 112 is not particularly limited and can include vents with dampers operable, directly or indirectly, by the passengers to regulate air flow or can include vents with directional vanes that can be closed by a passenger to regulate airflow. Conventionally, passenger operable vents 112 with dampers are preferred over vents with directional vanes that can also close the vent, despite the higher cost of such damper equipped vents, as the dampers provide a better seal, reducing the leakage of air through the close vent, compared to the directional vane vents. However, with the present invention vents which employ directional vanes to also close the vent can experience leakage rates that are as low, or lower, than damper equipped vents in prior art ventilation systems due to the reduction of the backpressure in the plenum with the present invention, when the vent is closed.

As will also now be apparent, when one or more passenger-operable vents 112 are closed, or partially open, there is an operating speed of the variable speed fan beyond which no additional air flow is created and the only net effect obtained in such a circumstance is to waste energy operating the fan at such speeds.. Such energy waste is undesired as it serves to lower the overall operating efficiency of the vehicle and is particularly undesired in vehicles employing electric or hybrid drive systems wherein energy management has a greater impact on acceptable operation of the vehicle.

The present invention provides an air flow control system and method for vehicle ventilation. The system and method operates such that the operating speed of the blower providing ventilation air changes to substantially maintain a selected air flow rate despite changes to the state of one or more passenger-operable vents. In a first embodiment, a pressure sensor in the air flow plenum provides a signal to a speed controller which alters the operating speed of the blower in view of the measured backpressure in the plenum.

The above-described embodiments of the invention are intended to be examples of the present invention and alterations and modifications may be effected thereto, by those of skill in the art, without departing from the scope of the invention which is defined solely by the claims appended hereto.

What is claimed is:

1. An air flow control system and method for vehicle ventilation comprises:
a ventilation air plenum;
at least two passenger-operable vents to provide ventilation air from the plenum to the interior of the vehicle, the vents being passenger-operable to move between closed, partially opened and opened states;
a variable speed air flow blower to provide ventilation air to the plenum;
a control unit operable to select a desired ventilation air flow rate;
at least one sensor operable to output a signal representing air flow through the passenger-operable vents in the open state; and
a speed controller responsive to the control unit and the signal from the at least one pressure sensor to alter the. operating speed of the blower to substantially maintain the desired air flow rate from each passenger-operable vent which is in the open state despite changes in the state of another passenger-operable vent.

2. The air flow control system of claim 1 wherein the blower obtains the ventilation air from a heat exchanger.

3. The air flow control system of claim 2 wherein the heat exchanger is a heater and air conditioning unit.

4. The air flow control system of claim 1 wherein the at least one sensor is a pressure sensor operable to indicate the pressure in the plenum.

5. The air flow control system of claim 1 wherein the passenger-operable vents are equipped with dampers to place the vents in the closed, partially open and open states.

6. The air flow control system of claim 1 wherein the passenger-operable vents are equipped with directional vanes to direct the airflow from the vent, the directional vanes also being moveable to a position to place the vents in the closed state.
